(19) United States
(12) Patent Application Publication
(10) Pub. No.: US 2026/0085979 A1
(43) Pub. Date: Mar. 26, 2026

(54) MEDICAL DEVICES AND RELATED METHODS FOR DETECTING A CHANGE IN TEMPERATURE

(71) Applicant: Axogen Corporation, Alachua, FL (US)

(72) Inventors: Jacob Quentin YARINSKY, Tampa, FL (US); Nathaniel LONG, Alachua, FL (US); Benjamin Scott SPEARMAN, Alachua, FL (US)

(73) Assignee: Axogen Corporation, Alachua, FL (US)

(21) Appl. No.: 18/898,244

(22) Filed: Sep. 26, 2024

(51) Int. Cl. G01K 3/00; B65D 79/02

(52) U.S. Cl. CPC G01K 3/005; B65D 79/02

(57) ABSTRACT

A device for detecting a temperature above a threshold temperature, the device including a first reservoir and a second reservoir fluidly connected to the first reservoir. When the device is exposed to a temperature at or below the threshold temperature, a material is disposed within the first reservoir. When the device is exposed to a second temperature greater than the threshold temperature, at least a portion of the material is disposed within the second reservoir.

### TECHNICAL FIELD

Various embodiments of the present disclosure relate generally to temperature detection devices and, more particularly, to devices configured for determining a change in temperature.

### BACKGROUND

Many different substances or devices may need to be maintained at a certain temperature, or within a certain temperature range, during storage or shipping. For example, biological tissues or substances, vaccines, pharmaceuticals, medical devices, foods, or certain chemicals may be stored or shipped as they pass along the supply chain. Such substances or products may be sensitive to temperature and, accordingly, must be shipped or stored in a temperature-controlled supply chain system. Deviation from a set temperature or a set temperature range at any point in the supply system may result in damage to or degradation of the substances or products. However, deviation from the set temperature may be difficult to determine, for example, throughout the supply system. This may be particularly true for transient temperature deviations, which may be harder to detect but may cause damage to the product. For example, if a product that was intended to remain frozen throughout the supply chain thawed for a period of time and then re-froze, damage could have been done to the product, but the transient deviation may be hard or impossible to detect once the product had re-frozen.

In particular, as a representative example, biological tissues (e.g., nerve grafts) may be preserved at ultra-low temperatures, e.g., cryopreservation temperatures, to prevent degradation during shipment or storage. The tissues may be shipped or stored at or below about 0 degrees Celsius, at or below about −20 degrees Celsius, at or below about −40 degrees Celsius, at or below about −80 degrees Celsius, or at or below about −196 degrees Celsius, or at or below any suitable temperature. Monitoring whether these temperatures are maintained during storage or shipping, and thus determining whether the biological tissues may have been damaged due to temperature change, may further increase costs associated with specialized refrigeration or packaging equipment needed to transport and store, e.g., cryopreserved tissue. Furthermore, many traditional devices, such as electrical devices, configured to measure temperature may be inoperable at such ultra-low temperatures.

There is a need, therefore, for a simple and cost-effective device that is able to determine deviation from a required temperature or temperature range during shipment or storage. The present embodiments are directed to overcoming one or more of these above-referenced challenges.

### DETAILED DESCRIPTION OF EMBODIMENTS

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±10% of a specified amount or value unless indicated otherwise in the specification. The use of the term “or” in the claims and specification is used to mean “and/or” unless explicitly indicated to refer to alternatives only or the alternatives are mutually exclusive, although the disclosure supports a definition that refers to only alternatives and “and/or.” As used herein “another” may mean at least a second or more.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” In addition, the term “between” used in describing ranges of values is intended to include the minimum and maximum values described herein.

The terms and expressions which have been employed are used as terms of description and not of limitation, and there is no intention that in the use of such terms and expressions of excluding any equivalents of the features shown and described or portions thereof, but it is recognized that various modifications are possible within the scope of the disclosure claimed.

Although the embodiments discussed herein are primarily in reference to the storage or shipment of biological tissues, such as nerve grafts, the disclosure may be used with other suitable biological products, devices, medications, food, etc. that require shipment or storage in a temperature-controlled environment. For example, embodiments of the disclosure may be used with epithelial tissue, connective tissue, vascular tissue, dermal tissue, skeletal tissue, muscle tissue, cardiac tissue, lung tissue, urological tissue, ligament tissue, adipose tissue, connective tissue, or nerve tissue. Further, the terms “nerve” and “nerve tissue” as used herein are used to describe any tissue to which the embodiments of the present disclosure may be applied.

Embodiments of the disclosure are drawn to a device for detecting a temperature above a threshold temperature. The device includes a first reservoir and a second reservoir fluidly connected to the first reservoir. When the device is exposed to a temperature at or below the threshold temperature, a material is disposed within the first reservoir. When the device is exposed to a second temperature greater than the threshold temperature, at least a portion of the material is disposed within the second reservoir.

Any of the devices disclosed herein may include any of the following features, additionally or alternatively, in any combination. The threshold temperature may be approximately −40 degrees Celsius. The threshold temperature may be approximately −20 degrees Celsius.

The device may further comprise a third reservoir in fluid communication with the first reservoir. The first reservoir may be disposed between the second reservoir and the third reservoir. A surface defining a floor of the first reservoir may be positioned relatively higher than a surface defining a floor of the second reservoir.

The device may further comprise a third reservoir in fluid communication with the first reservoir, and the second reservoir may be disposed between the first reservoir and the third reservoir. A surface defining a floor of the first reservoir may be positioned relatively higher than a surface defining a floor of the second reservoir and a surface defining a floor of the third reservoir. A first one-way valve may be disposed between the first reservoir and the second reservoir. A second one-way valve may be disposed between the first reservoir and the third reservoir. A second material may be disposed in the third reservoir at the temperature when the device is exposed to a third temperature below the threshold temperature. The second material may be different from the first material.

Embodiments of the disclosure are also drawn to a device for detecting a temperature above a threshold temperature. The device may include a frame defining a reservoir therein. The reservoir may include a plurality of arms extending radially out from a central portion. The reservoir may be configured to contain a material in one of the central portion or at least one arm of the plurality of arms when the device is exposed to a temperature below the threshold temperature, and, when the device is exposed to a temperature above the threshold temperature, the material may be at least partially disposed in a different portion of the reservoir.

Any of the devices disclosed herein may include any of the following features, additionally or alternatively, in any combination. The threshold temperature may be approximately −40 degrees Celsius. The threshold temperature may be approximately −20 degrees Celsius.

The material may be a first material disposed within one of the plurality of arms. A second material may be disposed in another arm of the plurality of arms. The first material may have a first melting temperature and the second material may have a second melting temperature. The first melting temperature may be greater than the second melting temperature. The first material may have a first color, and the second material may have a second color.

Embodiments of the disclosure are also drawn to a device for detecting a temperature above a threshold temperature. The device may include a cartridge for defining an internal cavity and a window, a testing paper disposed within the internal cavity and visible through the window, and at least one solution disposed within the internal cavity. At a temperature below the threshold temperature, the at least one solution may be in a solid state, and, at a temperature above the threshold temperature, the at least one solution may be at least partially in a liquid state such that the liquid contacts the testing paper, causing a reaction with the testing paper.

Any of the devices disclosed herein may include any of the following features, additionally or alternatively, in any combination. The testing paper may be configured to measure a pH of the at least one solution in the liquid state or a presence of an antibody in the at least one solution in the liquid state. A melting temperature of the at least one solution may be approximately equal to the threshold temperature.

The testing paper may be a first testing paper. The at least one solution may be a first solution. The device may further comprise a second testing paper and a second solution. A melting temperature of the first solution may be less than a melting temperature of the second solution.

The terms and expressions which have been employed are used as terms of description and not of limitation, and there is no intention that in the use of such terms and expressions of excluding any equivalents of the features shown and described or portions thereof, but it is recognized that various modifications are possible within the scope of the disclosure claimed.

### BRIEF DESCRIPTION OF THE DRAWINGS

The accompanying drawings, which are incorporated in and constitute a part of this specification, illustrate examples of the present disclosure and together with the description, serve to explain the principles of the disclosure.

FIGS. 1A-1C depict various views of an exemplary temperature detection device, according to aspects of this disclosure.

FIGS. 2A and 2B depict various views of an alternative exemplary temperature detection device, according to aspects of this disclosure.

FIGS. 3A and 3B depict perspective views of a further alternative exemplary temperature detection device, according to aspects of this disclosure.

FIGS. 4A and 4B depict perspective views of a further alternative exemplary temperature detection device, according to aspects of this disclosure.

FIGS. 5A and 5B depict perspective views of a further alternative exemplary temperature detection device, according to aspects of this disclosure.

FIGS. 6A and 6B depict perspective views of a further alternative exemplary temperature detection device, according to aspects of this disclosure.

FIGS. 7A and 7B depict perspective views of a further alternative exemplary temperature detection device, according to aspects of this disclosure.

FIGS. 8A and 8B depict perspective views of a further alternative exemplary temperature detection device, according to aspects of this disclosure.

FIGS. 9A and 9B depict perspective views of a further alternative exemplary temperature detection device, according to aspects of this disclosure.

FIGS. 10A-10D depict various views of a further alternative exemplary temperature detection device, according to aspects of this disclosure.

FIGS. 11A-11C depict various views of a further alternative exemplary temperature detection device, according to aspects of this disclosure.

FIGS. 12A-12C depict various views of a further alternative exemplary temperature detection device, according to aspects of this disclosure.

### DETAILED DESCRIPTION

Devices for determining if a change in temperature has occurred are discussed herein. In particular, embodiments of the present disclosure are drawn to devices for determining if a deviation from a desired temperature or temperature range has occurred, for example, during shipment or storage of a biological substance, such as a nerve graft.

Temperature control during the shipment or storage of nerve grafts may be critical to prevent degradation, damage, or spoilage of product. The nerve grafts may be shipped or stored at various temperatures. For example, the nerve grafts may be shipped or stored at or below about 0 degrees Celsius, at or below about −20 degrees Celsius, at or below about −40 degrees Celsius, at or below about −80 degrees Celsius, or at or below about −196 degrees Celsius. It may be difficult to determine if the nerve grafts have been exposed to undesirable temperatures throughout the supply chain. For example, although the nerve graft may be initially shipped and received at the required temperature, the nerve graft may unknowingly be exposed to temperatures above a required temperature or range of temperatures between the time the graft was initially shipped and the time the graft was received or used. For example, the graft may be sitting on a truck or in an airplane on a tarmac for extended time periods during warmer times of the year, and, during this time, the acceptable storage temperature of the graft may be exceeded. If the nerve graft is exposed to a temperature that is above (e.g., higher) than the required temperature or range of temperatures at any point, degradation, damage, or loss of the nerve graft may occur.

Accordingly, the devices discussed herein may provide a simple, mechanical, visual indicator that a temperature above a certain threshold has been reached at any point during shipment or storage. In particular, the devices discussed herein may contain one or more materials that undergo a phase change when the material(s) is/are exposed to temperatures above a threshold temperature. For example, if a device is exposed to temperatures above a phase transition temperature of the material(s) (e.g., the threshold temperature) contained within the device, the material(s) may deform, melt, change color, or otherwise provide a visual indication that a threshold temperature has been reached or exceeded at some point during shipment or storage.

The material(s) contained within the devices discussed herein may include one or more chemicals, compounds, or biological substances. Solutions may be tailored to achieve specific relevant melting points that are in line with upper temperature thresholds that different products may need to be stored below. As one example, saline solutions (e.g., calcium chloride) may be used with embodiments of the present disclosure. Varying the ratio of solvent to solute may result in a different freezing point for the saline solution. Adding one or more salts to a solvent, e.g., water, may lower the melting point. For example, a 38% w/v calcium chloride solution (CaCl₂) has a melting point of approximately −40 degrees Celsius. In some aspects, salt solutions, or other similar solutions, may be beneficial because they are non-toxic, non-flammable, and inexpensive to manufacture. In other aspects, other materials, or combinations of salts and materials, such as sugar, alcohol, etc., may be used to generate a solution with an appropriate melting point of interest.

As other examples, mercury has a melting point of approximately −38.83 degrees Celsius, 2-propanol has a melting point of approximately −89.5 degrees Celsius, acetone has a melting point of approximately −94 degrees Celsius, and isopropyl alcohol has a melting point of approximately −89 degrees Celsius. Combinations of two or more chemicals or compounds (e.g., by dilution in water or another suitable solvent) may result in a material having a melting point at approximately 0 degrees Celsius, approximately −20 degrees Celsius, approximately −40 degrees Celsius, approximately −80 degrees Celsius, approximately −196 degrees Celsius, or any other desired melting temperature based on the acceptable temperature range for the product being stored, shipped, or otherwise monitored. In other aspects, the melting points of various materials may be set to temperatures above the freezing point of pure water, e.g., by using liquids other than water or other solvents. Liquids or solutions with melting points of, e.g., approximately 0 to approximately 100 degrees Celsius, approximately 0 to approximately 50 degrees Celsius, approximately 0 to approximately 40 degrees Celsius, approximately 0 to approximately 25 degrees Celsius, etc., may be selected for use with products that need to be maintained at a temperature that falls below the relevant melting point. Furthermore, biological substances such as antibodies, hormones, etc., may be used in some examples to tailor the melting point for a given use case.

Throughout the following descriptions, a body of material (also referred to herein as a “material”) may be referenced or described in reference to the element within the temperature monitoring device that is configured to undergo a phase change when a threshold temperature is exceeded. The body of material may be comprised of any of the materials listed above, or any other suitable material or combination of materials that would have a desirable melting point suitable for the product being monitored. For example, the body of material may be comprised of a material that has a melting point that is approximately equal to or greater than a threshold for which the product (e.g., a nerve graft) may be exposed to. Such melting points may include, for example, approximately 0 degrees Celsius, approximately −20 degrees Celsius, approximately −40 degrees Celsius, approximately −80 degrees Celsius, or any other desired temperature.

In some figures, the material may be in a first (e.g., frozen) state. For example, the body of material may be exposed to a first temperature, or a first range of temperatures, in the first state. The first temperature or the first range of temperatures may be lower than the melting temperature point of the material disposed within the device. In other figures, the material may be in a second (e.g., at least partially deformed or melted) state. For example, the second state of the material may be indicative that the material has been (or is being) exposed to a temperature greater than the freezing or melting point of the material disposed within the device. The second state may include a material in a frozen, or re-frozen, state. In these aspects, prime elements may be used in the following figures, for example, to indicate the material is in the second state. For example, “material 106” may be used to indicate the material is in the first state, and “material 106′” may be used to indicate the material is in the second state.

Furthermore, the exemplary shapes or sizes of the devices or materials contained within the devices illustrated in the following figures and discussed herein are exemplary. For example, throughout various figures, the material, particularly in the frozen state, is shown as a cylindrical, cuboidal, rectangular, spherical, polyhedric, etc. mass. However, it may be understood that alternative suitable shapes (e.g., a pyramid, a triangular prism, a cone, etc.) may be used.

Wherever possible, the same or similar reference numbers will be used through the following figures to refer to the same or like parts. Accordingly, between different embodiments, like numbers will be used to refer to like features, with “100” added to each numeral. Any of the devices disclosed herein may include any of the following features, additionally or alternatively, in any combination.

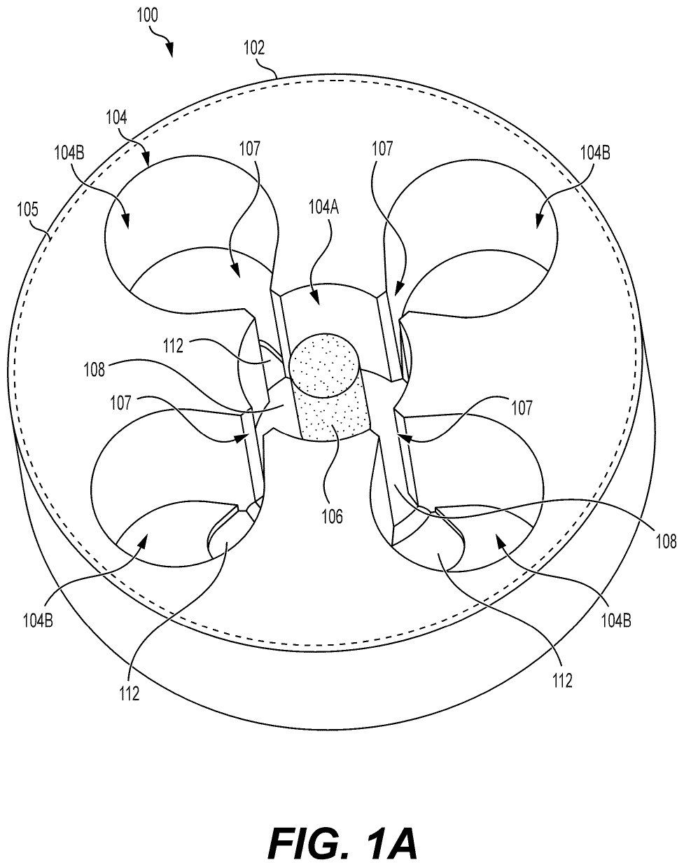

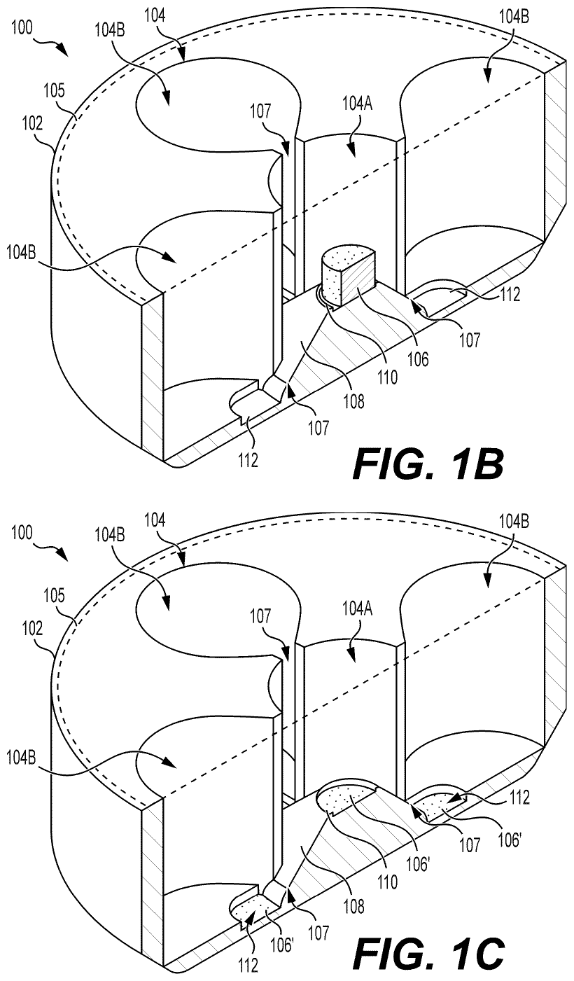

FIG. 1A depicts a perspective view of a detection device 100 at a first temperature or a first range of temperatures below a threshold temperature. FIG. 1B depicts a vertical cross-section of detection device 100 at the first temperature, and FIG. 1C depicts a vertical cross-section of detection device 100 at a second temperature above the threshold temperature. Accordingly, the second temperature may be greater than the first temperature. For example, the second temperature may be greater than a melting temperature of a material 106 disposed within detection device 100, which may be selected in order to correspond to a temperature above a suitable storage temperature of a product packaged with detection device 100. FIGS. 1A-1C may be referred to interchangeably throughout the following description.

Detection device 100 may include a frame 102 defining a plurality of reservoirs 104. The plurality of reservoirs 104 may include a central reservoir 104A and one or more surrounding reservoirs 104B. For example, FIG. 1A illustrates four surrounding reservoirs 104B radially arranged about central reservoir 104A. In other aspects, frame 102 may define one, two, three, five, etc. surrounding reservoirs 104B. In some aspects, a center point of each surrounding reservoir 104B may be equally spaced from a center point of central reservoir 104A. Additionally or alternatively, each of surrounding reservoirs 104B may be equally spaced apart from one another. For example, as illustrated in FIG. 1A, surrounding reservoirs 104B may be spaced approximately 90 degrees apart from one another. In other aspects, surrounding reservoirs 104B may be unequally spaced from one another around central reservoir 104A.

As illustrated in FIG. 1A, each reservoir of the plurality of reservoirs 104 (e.g., central reservoir 104A and surrounding reservoirs 104B) may have a same diameter or a same cross-sectional shape. For example, a cross-sectional shape of each of the plurality of reservoirs 104 may be generally circular (as shown), or ovular. In other aspects, one or more of the plurality of reservoirs 104 may have a different diameter or shape. For example, a cross-sectional shape of one or more reservoirs of the plurality of reservoirs 104 may be square, or a diameter of one or more reservoirs of the plurality of reservoirs 104 may be smaller or larger than the other reservoirs.

Each surrounding reservoir 104B may be in fluid communication with central reservoir 104A. For example, a channel 107, or an opening, may extend between central reservoir 104A and each surrounding reservoir 104B. Channels 107 may permit flow of a material 106′ (e.g., material 106 in a melted state) from central reservoir 104A, into one or more of surrounding reservoirs 104B, as illustrated in FIG. 1C. A width of each of channel 107 may be less than a diameter of material 106, for example, to prevent material 106 from moving into the one or more surrounding reservoirs 104B in the first state.

In some aspects, a one-way valve (not shown) may be disposed within one or more channels 107. For example, a valve may be disposed between central reservoir 104A and at least one surrounding reservoir 104B. In aspects, the valve may permit flow of material 106′ from central reservoir 104A into surrounding reservoirs 104B, and may prevent flow of material 106′ from surrounding reservoirs 104B into central reservoir 104A.

In some aspects, a sloped surface 108 may extend between central reservoir 104A and each surrounding reservoir 104B. In aspects, channels 107 may be at least partially defined by sloped surface 108. For example, sloped surface 108 may form a base, or a floor, of channels 107. Sloped surface 108 may be sloped, or angled downward towards each surrounding reservoir 104B, for example, to facilitate flow of material 106′ into one or more surrounding reservoirs 104B (e.g., when device 100 is exposed to the second temperature above the threshold temperature). In other words, sloped surface 108 may be relatively higher at or adjacent central reservoir 104A, while sloped surface 108 may be relatively lower at or adjacent surrounding reservoirs 104B. Although a sloped surface 108 is described, surface 108 may alternatively be flat, such that the floor height of central reservoir 104A and the floor height of surrounding reservoirs 104B are positioned at equal heights to one another.

In some aspects, a base of each reservoir of the plurality of reservoirs 104 may include an indentation or depression. For example, central reservoir 104A may include a central indentation 110, and surrounding reservoirs 104B may include surrounding indentations 112. At the first temperature, all of material 106 may be disposed within central reservoir 104A, for example, in central indentation 110, and may be present in a solid state. Accordingly, central indentation 110 may assist in maintaining a position of material 106 within central reservoir 104A. Surrounding indentations 112 may facilitate accumulation of melted, liquid material 106′ within each respective surrounding reservoir 104B, for example, at the second temperature above the threshold temperature. In other aspects, indentations 112 may be configured to hold contact indicators (not shown). For example, should solid material 106 begin to melt, forming liquid material 106′, liquid material 106′ would contact the contact indicators contained within indentations 112, causing the contact indicators to change color or shape or otherwise change appearance. Accordingly, the contact indicators contained within indentations 112 (if used) may provide an additional visual indicator for a user.

Although indentations 110 and 112 are depicted in FIGS. 1A-1C, they are not necessary for proper function of device 100, and the floors of reservoirs 104 may not include indentations. In similar aspects, moisture contact indicators (not shown) may be placed within each respective surrounding reservoir 104B (e.g., not within an indentation 112).

In some aspects, a covering 105 may extend over the plurality of reservoirs 104. Covering 105 is illustrated in FIGS. 1A-1C using broken lines, for example, to permit visualization of aspects of frame 102 and material 106/106′. Covering 105 may be fixed to frame 102. For example, covering 105 may be a lid or a seal configured to keep material 106/106′ disposed within frame 102. In some aspects, covering 105 may be translucent or transparent, thereby allowing a user to view the plurality of reservoirs 104 and material 106/106′.

During use, detection device 100 may be placed in, with, or near temperature-sensitive products (e.g., during shipment or storage). Should device 100 be exposed to a temperature that is higher than the melting point of the material forming material 106, material 106 may at least partially melt or deform. Accordingly, material 106′ (e.g., material 106 in an at least partially melted or deformed state), may flow into one or more surrounding reservoirs 104B.

Upon receipt or use of the temperature-sensitive products, device 100 may be observed by a user. Deformation of material 106 within central reservoir 104A or presence of material 106′within one or more surrounding reservoirs 104B may provide a visual indication to the user that device 100 (and, accordingly, the temperature-sensitive products positioned with device 100) has been exposed to an undesirable temperature.

Material 106 may be disposed within central reservoir 104A, for example, at a first temperature. Material 106 may be comprised of any of the materials, chemicals, or compounds discussed above (e.g., mercury, isopropyl alcohol, etc.). In aspects, material 106 may be initially disposed within central reservoir 104A in a first, solid or frozen, state (e.g., at a first temperature). For example, material 106 may be disposed only within central reservoir 104A when detection device 100 is at the first temperature. The first temperature may be less than the melting point of the material comprising material 106. At a second temperature (e.g., a temperature that is above the melting point of material 106), material 106 may at least partially melt or deform.

Accordingly, material 106′ may flow from central reservoir 104A to one or more surrounding reservoirs 104B. As described above, the presence of material 106′ in any surrounding reservoirs 104B may indicate that the temperature exceeded the threshold melting temperature of material 106.

In some aspects, if one-way valves are used to allow the flow of material 106′ into surrounding reservoirs 104B and to prevent the flow back into central reservoir 104A, then the melted material 106′ will be kept in one or more of the surrounding reservoirs 104B for later visual observation by a user. In that way, the user will be aware of the increase in temperature that exceeded the threshold temperature. In some aspects, if indentations 112 are used, then the inclusion of indentations 112 in the surrounding reservoirs 104B may allow melted material 106′ to pool within one or more of the surrounding reservoirs 104B, facilitating visualization.

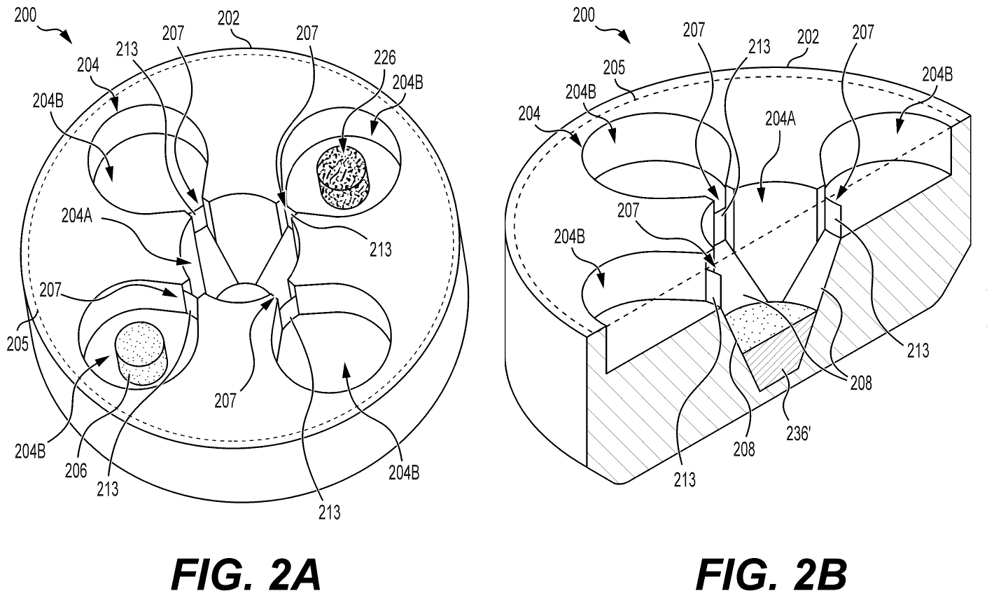

FIGS. 2A and 2B illustrate an alternative exemplary detection device 200. In particular, FIG. 2A illustrates a perspective view of detection device 200, and FIG. 2B illustrates a vertical cross-section of detection device 200. Detection device 200 may have any or all of the same characteristics of detection device 100, except as described below. For example, detection device 200 may include a frame 202 defining a plurality of reservoirs 204. A central reservoir 204A may be defined, and one or more surrounding reservoirs 204B may be defined around central reservoir 204A. Each of surrounding reservoirs 204B may be in fluid communication with central reservoir 204A via a channel 207 extending therebetween. At a first temperature, a material 206 may be disposed within one or more surrounding reservoirs 204B. At a second, increased temperature, material 206 may at least partially melt, or deform, such that, for example, a material 206′ (e.g., material 206 in a melted state) flows into central reservoir 204A. Material 206/206′ may be comprised of any material or combination of materials previously discussed.

A sloped surface 208 may extend between central reservoir 204A and each surrounding reservoir 104B. For example, sloped surface 208 may form a base, or a floor, of channels 207. Sloped surface 208 may be sloped, or angled, towards central reservoir 204A, for example, to facilitate flow of a material 206′ from at least one of surrounding reservoirs 204B. In other words, sloped surface 208 may be relatively lower at or adjacent central reservoir 204A, while sloped surface 208 may be relatively higher at or adjacent surrounding reservoirs 204B. Although a sloped surface 208 is described, surface 208 may alternatively be flat, such that the floor height of central reservoir 204A and the floor height of surrounding reservoirs 204B are positioned at equal heights to one another.

In some aspects, a one-way valve 213 may be disposed within one or more channels 207. For example, valve 213 may be disposed between central reservoir 204A and at least one surrounding reservoir 204B. In aspects, valve 213 may permit flow of material 206′ from surrounding reservoirs 204B into central reservoir 204A, and prevent flow of material 206′ from central reservoir 204A into surrounding reservoirs 204B.

A covering 205 may extend over the plurality of reservoirs 204. Covering 205 is illustrated in FIGS. 2A and 2B using broken lines, for example, to permit visualization of aspects of frame 202 and material 206/206′. Covering 205 may be permanently or removably fixed to frame 202. For example, covering 205 may be a lid or a seal configured to keep material 206/206′ disposed within frame 202. In some aspects, covering 205 may be translucent or transparent, thereby allowing a user to view the plurality of reservoirs 204 and material 206/206′.

During use, material 206 may be initially disposed within the one more surrounding reservoirs 204B in a first solid, or frozen, state (e.g., at a first temperature below a first threshold). For example, material 206 may be disposed only within one or more surrounding reservoirs 204B when detection device 200 is at the first temperature. The first temperature may be less than the threshold temperature, which may correspond to the melting point of the material comprising material 206. At the second temperature (e.g., a temperature equal to or greater than the melting point of the material comprising material 206 and above the threshold), material 206 may at least partially melt or deform. The melted material 206′ may flow into, or towards central reservoir 204A. Accordingly, presence of material 206′ in the central reservoir 204A may provide a visual indication that detection device 200 was exposed to a temperature greater than the threshold melting point of material 206.

In some aspects, as is shown in FIG. 2A, material 206 may be a first material, and detection device 200 may include a second material 226 disposed in another of the one or more surrounding reservoirs 204B in a first solid, or frozen, state (e.g., at a first temperature below a threshold temperature). Second material 226 may be any of the materials previously discussed. Second material 226 may be the same as first material 206. In other aspects, second material 226 may be different from first material 206. Accordingly, second material 226 may have a different melting point, and thus a different threshold temperature, as compared to first material 206. For example, second material 226 may have a threshold melting point that is greater than the threshold melting point of first material 206. Accordingly, during use, melting or deformation of second material 226 may be an indication that detection device 200 was exposed to a second, higher temperature.

For example, during use, detection device 200 may be exposed to a first temperature that is at or below the threshold melting points of both first material 206 and second material 226. When detection device 200 is exposed to a second temperature that is higher than the threshold melting point of first material 206, but lower than a threshold melting point of second material 226, first material 206 may at least partially melt of deform. Accordingly, first material 206′ may be observed in central reservoir 204A. When detection device 200 is exposed to a third temperature that is higher than the threshold melting points of both first material 206 and second material 226, second material 226 may also at least partially melt or deform. Accordingly, second material 226′ may also be observed in central reservoir 204A.

In some aspects, first material 206/206′ may include a dye or a colorant, or second material 226/226′ may include a second dye or colorant that is different than the first dye or colorant. Accordingly, when first material 206′ contacts second material 226′ within central reservoir 204A, a color change may occur. For example, first material 206/206′ may include a blue dye or colorant, and second material 226/226′ may include a yellow colorant such that, for example, when first material 206′ contacts second material 226′ within central reservoir 204A, the resulting combination of materials may be green. Or, if the materials don't mix (e.g., like oil and water), then both colors may be seen within central reservoir 204A.

Thus, if a user sees material that has the same color as first material 206′ within central reservoir 204A, then the user knows that device 200, and anything located with or near device 200, was exposed to a temperature that was higher than a first threshold corresponding to a melting point of first material 206′, but lower than a second threshold corresponding to a melting point of second material 226′. Alternatively, if a user sees material that has a color that is different than the color of material 206′ within central reservoir 204A, then the user knows that device 200, and anything located with or near device 200, was exposed to a temperature that was higher than a first threshold corresponding to a melting point of first material 206′, and higher than a second threshold corresponding to a melting point of second material 226′. In some aspects, the first threshold temperature may be selected to correspond to a temperature that has a first impact on a product packaged with device 200, while a second threshold temperature may be selected to correspond to a temperature that has a second impact on a product packaged with device 200. For example, the surpassing the first threshold temperature may shorten the shelf life of the product, whereas surpassing the second threshold temperature may spoil the product. Or, surpassing the first threshold temperature may indicate that the product might be impacted by the change in temperature, triggering further inspection or testing, whereas surpassing the second threshold temperature may spoil the product.

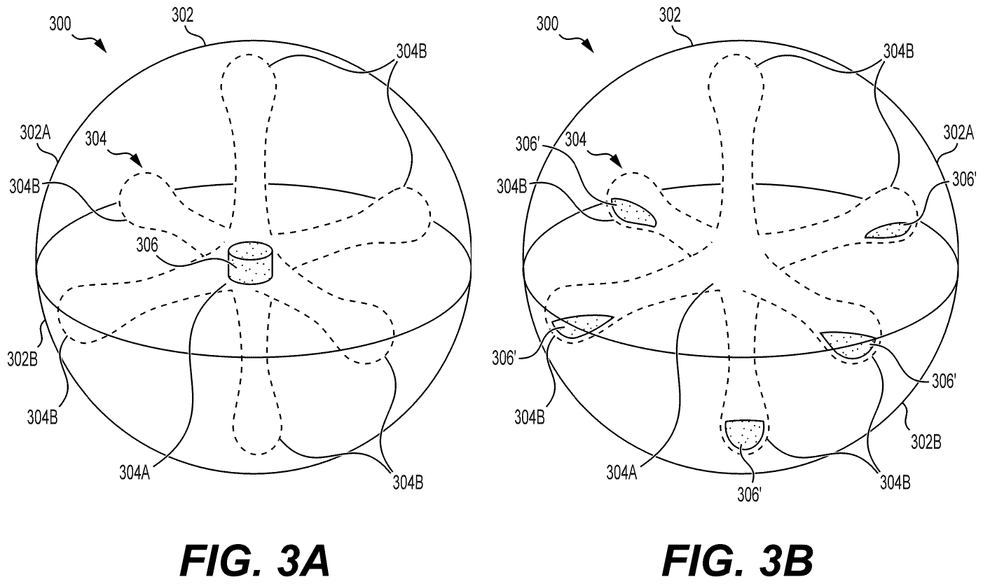

FIGS. 3A and 3B illustrate an alternative exemplary detection device 300. In particular, FIG. 3A illustrates detection device 300 at a first temperature, below a threshold, and FIG. 3B illustrates detection device 300 at a second (e.g., higher or increased) temperature, above the threshold.

Detection device 300 may include a frame 302 defining an internal reservoir 304. Frame 302 may be comprised of a transparent or semi-transparent material, for example, to permit visualization of internal reservoir 304. In aspects, frame 302 may be a sphere, as shown in FIGS. 3A and 3B. In other aspects, frame 302 may be a cube, a rectangular prism, a cylinder, or any other 3-dimensional shape.

Internal reservoir 304 of frame 302 may include a plurality of arms 304B extending radially outward from a central portion 304A and fluidly coupled to central portion 304A. Although internal reservoir 304 is illustrated as having six arms 304B, reservoir 304 of detection device 300 may include additional or fewer arms 304B of different suitable shapes or sizes. Internal reservoir 304 (e.g., arms 304B and central portion 304A) is illustrated in FIGS. 3A and 3B using broken lines, for example, to indicate reservoir 304 is entirely disposed within frame 302. In some aspects, respective ends of each arm of the plurality of arms 304B may have a bulbous, or expanded, portion where liquid material may pool.

Detection device 300 may further include a material 306. For example, material 306 may be comprised of any of the materials previously discussed. Material 306 may be disposed within central portion 304A of internal reservoir 304 at the first temperature (e.g., FIG. 3A). Material 306 may be sized or positioned so that material 306 remains within central portion 304A when in a solid state below the threshold. At the second temperature above the threshold, material 306 may at least partially melt or deform. For example, material 306′ (e.g., material 306 in an at least partially melted state) may flow into one or more arms 304B. Accordingly, presence of material 306′ within the one or more arms 304B of internal reservoir 304 may provide a visual indication to a user that detection device 300 was exposed to a temperature greater than the threshold melting point of material 306.

The shape of reservoir 304, with arms radiating in multiple planes away from the central portion 304A, may facilitate the flow of material 306′ out from central portion 304A when device 300 is in any orientation. This may be useful, e.g., during shipment of the product with which device 300 may be packaged, if the orientation of the device changes during shipment.

Although not shown in FIGS. 3A and 3B for simplicity, one-way valves may be located between central portion 304A and the one or more arms 304B. The valves may allow the flow of material 306′ out from central portion 304A and into arms 304B but may prevent the flow of material 306′ back into central portion 304A to facilitate observation by a user that material 306′ had flowed into one or more arms 304B at a point in time.

Frame 302 may be formed a variety of ways. For example, frame 302 may be molded, 3D-printed, otherwise formed in at least two portions (e.g., a first half 302A of frame 302 and a second half 302B of frame 302). A portion of reservoir 304 may be formed as a negative space within each respective half 302A, 302B. First half 302A and second half 302B may be configured to couple together, thus forming frame 102 as shown in FIGS. 3A and 3B. For example, first half 302A and second half 302B may be fixedly coupled together (e.g., using an adhesive, a weld, etc.) or removably coupled together (e.g., via mechanical fasteners, friction fit, twist fit, or other means).

In some aspects, one of first half 302A or second half 302B may include a plurality of threads, and the other of first half 302A or second half 302B may include a plurality of receiving threads to engage with the plurality of threads. Accordingly, rotation of first half 302A relative to second half 302B, or vice versa, may result in first half 302A and second half 302B being coupled together. Prior to coupling first half 302A and second half 302B, material 306 may be disposed within central portion 304A of reservoir 304 formed within first half 302A or second half 302B.

In other aspects, half 302A or second half 302B may include one or more ridges or indentations that allow the two halves to snap-fit or friction-fit together. Prior to coupling first half 302A and second half 302B, material 306 may be disposed within central portion 304A of reservoir 304 formed within first half 302A or second half 302B.

In other aspects, frame 302 may be formed all at once, e.g., via 3D printing, with central portion 304A of reservoir 304 formed inside, and material 306 may be inserted during the formation process.

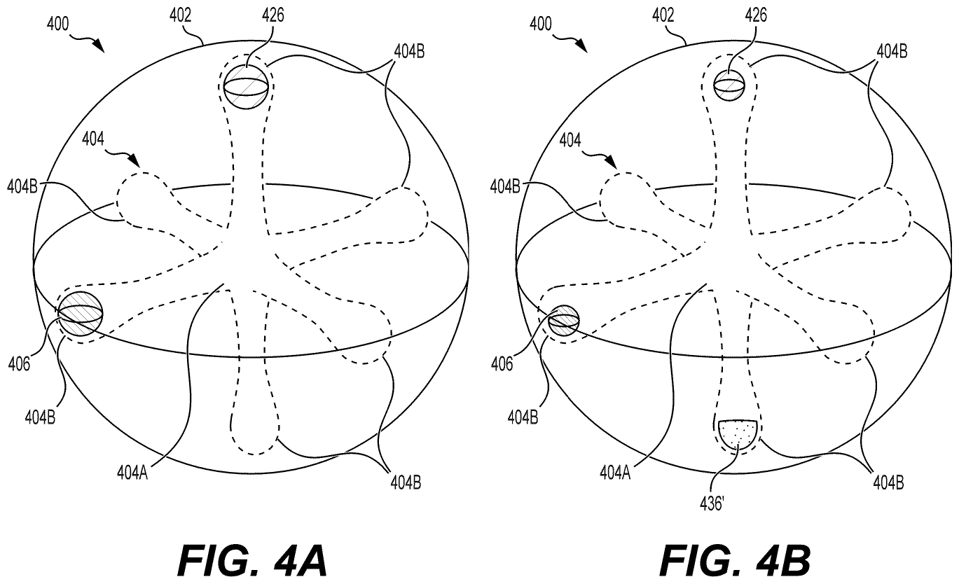

FIGS. 4A and 4B illustrate an alternative exemplary detection device 400 at a first temperature below a threshold melting point of a first material 406 (FIG. 4A) and a second temperature above the threshold melting point of first material 406 (FIG. 4B). Detection device 400 may have any or all of the characteristics of detection device 300, as discussed above. For example, detection device 400 may include a frame 402 that defines an internal reservoir 404. Internal reservoir 404 may include a plurality of arms 404B extending radially outward, for example, from a central portion 404A.

First material 406 may be disposed within an end of one or more arms of the plurality of arms 404B. In some aspects, a second material 426 may be disposed within an end of another arm of the plurality of arms 404B. In some aspects, first material 406 may be the same material as second material 426. Accordingly, first material 406 and second material 426 may have a same melting temperature. For example, when detection device 400 is exposed to the second temperature, above the threshold, first material 406 and second material 426 may at least partially melt or deform. In these aspects, the at least partially melted first material 406′ or the at least partially melted second material 426′ may be observed in additional arms of the plurality of arms 404B, or within central portion 404A. In some aspects, first material 406 and second material 426 may decrease in size. Accordingly, presence of the at least partially melted or deformed first material 406′ or the at least partially melted or deformed second material 426′ within one of the arms of the plurality of arms, or within central portion 404A, may be observed. In some aspects, the same material, or material having the same melting point, may be located within each of the arms 404B, and the presence of melted material within the central portion 404A may indicate that device 300 has been exposed to a temperature above the threshold melting temperature of the material.

In other aspects, first material 406 may be different from second material 426. For example, first material 406 may have a different melting temperature as compared to second material 426, as described with reference to the multiple materials of FIG. 2A. For example, during use, detection device 400 may be exposed to a first temperature that is at or below the threshold melting points of both first material 406 and second material 426. When detection device 400 is exposed to a second temperature that is higher than the threshold melting point of first material 406, but lower than the threshold melting point of second material 426, first material 406 may at least partially melt of deform. Accordingly, first material 406′ may be observed in one or more other arms of the plurality of arms 404B or in the central portion 404A. When detection device 400 is exposed to a third temperature that is higher than the threshold melting points of both first material 406 and second material 426, second material 426 may also at least partially melt or deform. Accordingly, second material 426′ may also be observed in one or more other arms of the plurality of arms 404B or in the central portion 404A.

In some aspects, first material 406/406′ may include a first dye or a colorant, or second material 426/426′ may include a second dye or colorant, different than the first dye or colorant. Accordingly, when first material 406′ contacts second material 426′ within internal reservoir 404, a color change may occur. For example, first material 406/406′ may include a blue dye or colorant, and second material 426/426′ may include a yellow dye or colorant such that, for example, when first material 406′ contacts second material 426′ within internal reservoir 404, the resulting combination of materials may be green.

Although not shown in FIGS. 4A and 4B for simplicity, one-way valves may be located between central portion 404A and the one or more arms 404B. The valves may allow the flow of material 406′ into central portion 404A from arms 404B, but may prevent the flow of material 406′ back into arms 404B to facilitate observation by a user that material 306′ had flowed into one or more arms 304B at a point in time.

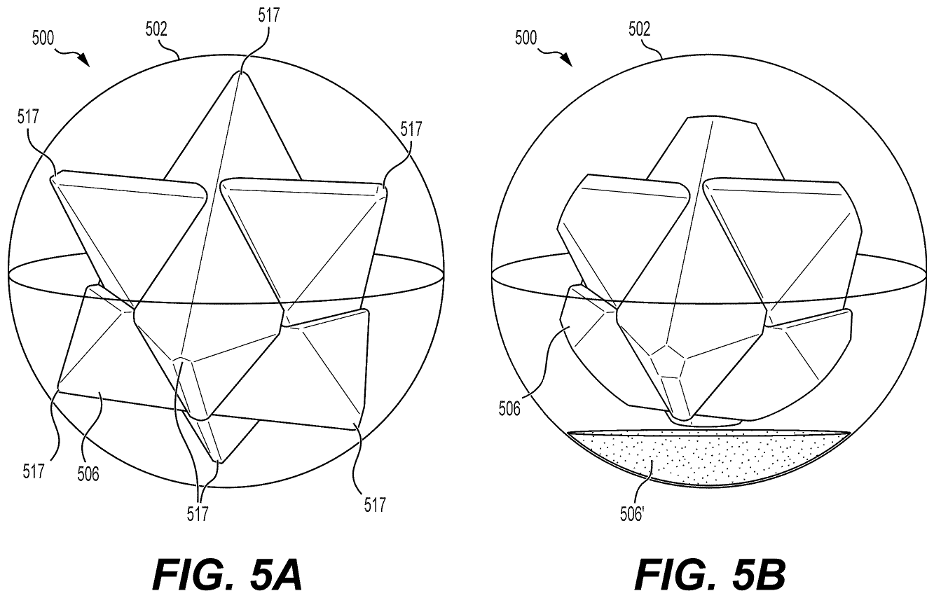

FIGS. 5A and 5B illustrate an alternative detection device 500. For example, FIG. 5A illustrates detection device 500 at a first temperature, below a threshold temperature, and FIG. 5B illustrates detection device 500 at a second temperature, above the threshold temperature. Detection device 500 may include a container 502. A material 506 may be disposed within container 502. Container 502 is illustrated as a sphere in FIGS. 5A and 5B, although container 502 may be any exemplary shape configured to contain material 506. Material 506 may be any of the materials or combinations of materials discussed above.

At the first temperature, material 506 may be solid or frozen in a first shape when below the threshold temperature. For example, material 506 is illustrated as having a polyhedron shape at the first temperature, although other 3-dimensional shapes of material 506, such as pyramids, cones, stars, etc., may be contemplated. The threshold temperature may correspond to a melting point of material 506. At the second temperature above the threshold temperature, a shape of material 506 may change, thus indicating detection device 500 has been exposed to a second temperature, above the threshold temperature. For example, the polyhedron shape of material 506 at the first temperature below the threshold temperature, may define a plurality of points. At the second temperature, material 506 may at least partially melt or deform such that, for example, one or more points of the plurality of points become rounded. In some aspects, a material 506′ (e.g., material 506 in an at least partially melted or deformed state) may also pool or accumulate within container 502.

A change of shape of material 506 or accumulation of material 506′ within container 502 may be indicative that detection device 500 has been exposed to a temperature at or above a threshold melting temperature of material 506.

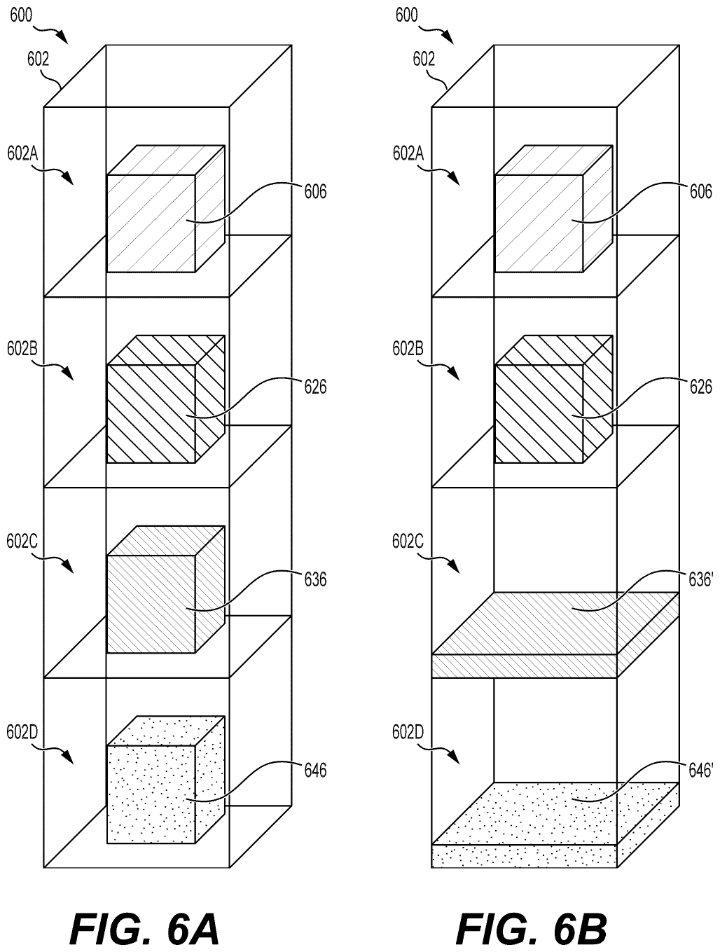

FIGS. 6A and 6B illustrate an exemplary alternative detection device 600. FIG. 6A illustrates detection device 600 at a first temperature, and FIG. 6B illustrates detection device 600 at a second temperature. Detection device 600 may have any or all of the same characteristics of detection devices 100, 200, 300, 400, or 500, except as described below. Detection device 600 may be configured to provide a visual indication that detection device 600 was exposed to undesirable temperature above a threshold temperature.

Detection device 600 may include one or more reservoirs 602 coupled to or arranged adjacent one another. For example, FIGS. 6A and 6B illustrate four reservoirs (e.g., a first reservoir 602A, a second reservoir 602B, a third reservoir 602C, and a third reservoir 602D). However, detection device 600 may include fewer reservoirs or additional reservoirs. Each of reservoirs 602 may be independent from one another. For example, fluid may not be permitted to flow between reservoirs (e.g., between first reservoir 602A and second reservoir 602B, between second reservoir 602B and third reservoir 602C, etc.).

Each of the one or more reservoirs 602 may be configured to contain one or more materials. For example, first reservoir 602A may contain a first material 606, second reservoir 602B may contain a second material 626, third reservoir 602C may contain a third material 636, and fourth reservoir 602D may contain a fourth material 646. Each material 606, 626, 636, 646 may be a same material or at least one of material 606, 626, 636, 646 may be a different material. Accordingly, material 606, 626, 636, 646 may each have a same or different melting temperature.

For example, when detection device 600 is exposed to the first temperature below a first threshold temperature, none of materials 606, 626, 636, 646 may melt or deform. The first threshold temperature may be less than a melting temperature of each material 606, 626, 636, 646. If detection device 600 is exposed to a second temperature above the first threshold temperature, one or more of materials 606, 626, 636, 646 may melt or deform. For example, materials 636, 646 may at least partially melt or deform if detection device 600 is exposed to a temperature that is greater than a melting temperature of materials 636 and 646. Upon melting or at least partially deforming, materials 636′, 646′ (e.g., materials 636, 646 in an at least partially melted or deformed state) may be contained within reservoirs 602C, 602D, respectively.

In these aspects, detection device 600 may provide a visual indication of the temperatures that detection device 600 was exposed to. Should materials 606, 626, 636, 646 have different melting temperatures, a user may be able to approximate a highest temperature that detection device 600 was exposed to. For example, a melting threshold temperature of first material 606 may be different from a melting threshold temperature of second material 626, which may be different than a melting threshold temperature of third material 636, which may be different than a melting threshold temperature of third material 636. In some aspects, a threshold melting temperature of the first material 606 may be approximately 0 degrees Celsius, a threshold melting temperature of the first material 606 may be approximately −20 degrees Celsius, a threshold melting temperature of second material 626 may be approximately −40 degrees Celsius, a threshold melting temperature of third material 636 may be approximately −60 degrees Celsius, and a threshold melting temperature of fourth material 646 may be approximately −80 degrees Celsius. If detection device 600 is exposed to a temperature of approximately −50 degrees Celsius, third material 636 and fourth material 646 may at least partially melt or deform, as illustrated in FIG. 6B.

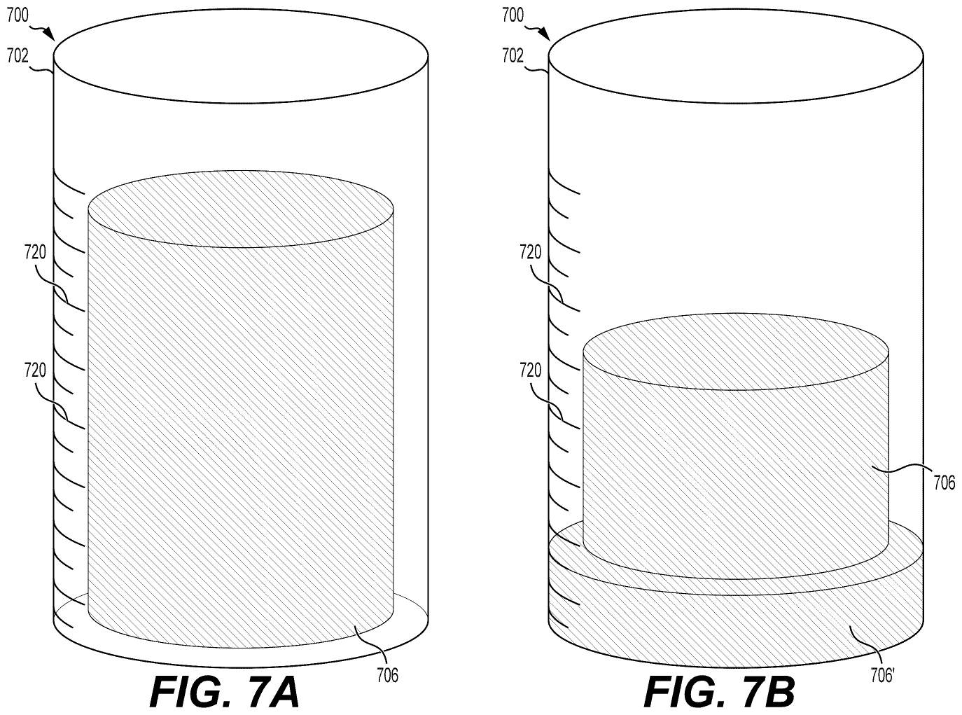

FIGS. 7A and 7B illustrate an alternative exemplary detection device 700 at a first temperature below a threshold temperature (FIG. 7A) and a second temperature above the threshold temperature (FIG. 7B). Detection device 700 may have any or all of the same characteristics of detection device 100, 200, 300, 400, 500, or 600, except as described below. Detection device 700 may include a reservoir 702 having a plurality of markings 720 disposed thereon. The plurality of markings 720 may be similar to those on a graduated cylinder. In these aspects, the plurality of markings 720 may be configured to indicate a volume.

A material 706 may be disposed within reservoir 702. For example, at the first temperature, material 706 may be in a frozen or solid state. The first temperature may be below a melting temperature of material 706. Upon being exposed to the second temperature above the threshold temperature, material 706 may at least partially melt or deform. For example, a material 706′ (e.g., material 706 in an at least partially melted or deformed state) may be contained within reservoir 702 at the second temperature.

A user may utilize the plurality of markings 720, for example, to estimate a volume of material 706′ that is within detection device 700 (e.g., a volume of material 706 that has been melted). Such information may be used, for example, to estimate an amount of time detection device 700 has been exposed to the second temperature. For example, the more time detection device 700 has been exposed to the second temperature, a greater volume of material 706′ may be observed.

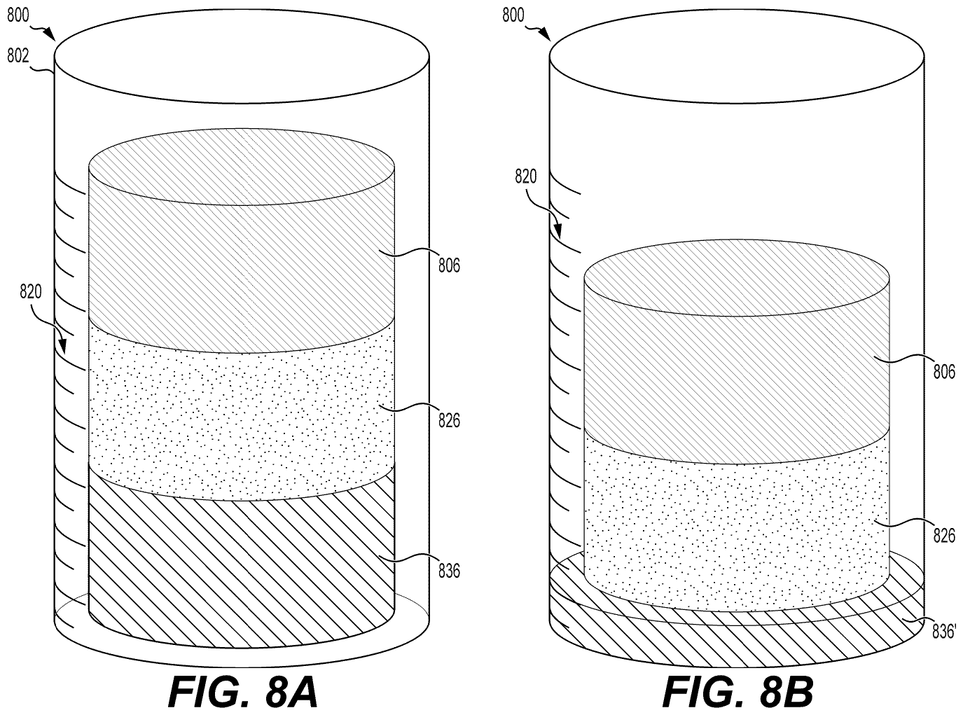

FIGS. 8A and 8B illustrate an alternative exemplary detection device 800 at a first temperature (FIG. 8A) and a second temperature (FIG. 8B). Detection device 800 may have any or all of the same characteristics of detection device 100, 200, 300, 400, 500, or 600, or 700, except as described below. In particular, detection device 800 may have any or all of the same characteristics of detection device 700, except as described below.

For example, detection device 800 may include a reservoir 802 having a plurality of markings 820 (e.g., graduations). One or more materials may be disposed within reservoir 802. For example, a first material 806, a second material 826, and a third material 836 may be disposed within reservoir 802. While three materials are shown in the figures for reference, additional materials or fewer materials may be disposed within reservoir 802. In some aspects, first material 806, second material 826, or third material 836 may be stacked upon one another, or layered in any order. In some aspects, first material 806, second material 826, or third material 836 may be integrally formed with one another (e.g., frozen or molded together), or may be separate.

Similar to detection devices 200, 400, or 600, detection device 800 may be utilized, for example, to approximate a highest temperature above which detection device 800 has been exposed. Similar to detection device 700, plurality of markings 820 may be utilized, for example, to determine a length of time detection device 800 has been exposed to the highest temperature.

For example, when detection device 800 is exposed to the first temperature below a first threshold temperature, none of materials 806, 826, 836 may melt or deform, as shown in FIG. 8A. First temperature may be less than a threshold melting temperature of each of material 806, 826, and 836. If detection device 800 is exposed to a second temperature above the first threshold temperature, one or more of materials 806, 826, 836 may at least partially melt or deform. For example, material 806 may at least partially melt or deform if detection device 800 is exposed to a temperature that is greater than the first threshold temperature, wherein the first threshold temperature corresponds to a melting temperature of material 806. Upon melting or at least partially deforming, material 806′ (e.g., materials 806 in an at least partially melted) may be contained within reservoir 802. In some aspects, a second threshold temperature may correspond to a melting point of material 826, which may be higher than the first threshold temperature, and a third threshold temperature may correspond to a melting point of material 836, which may be higher than the second threshold temperature. In this aspect, material 826 may at least partially melt or deform (in addition to material 806) if device 800 is exposed to a temperature between that of the first threshold and the second threshold, and material 836 (in addition to materials 806, 826) may also at least partially melt or deform if device 800 is exposed to a temperature greater than above the second threshold.

In these aspects, detection device 800 may provide a visual indication of the temperatures that detection device 800 was exposed to. Should materials 806, 826, 836 have different melting temperatures, a user may be able to approximate a highest temperature range that detection device 800 was exposed to. For example, a threshold melting temperature of first material 806 may be approximately −60 degrees Celsius, a threshold melting temperature of second material 826 may be approximately −40 degrees Celsius, and a threshold melting temperature of third material 836 may be approximately −20 degrees Celsius. If detection device 800 is exposed to a temperature of approximately −50 degrees Celsius, first material 806 may at least partially melt or deform, as illustrated in FIG. 8B.

Additionally, a volume of each melted material may be used to approximate an amount of time detection device 800 has been exposed to the higher temperatures. For example, a larger volume of material 806′ may indicate detection device 800 has been exposed to a temperature above the melting point of 806 for longer period of time.

In some aspects, each of materials 806, 826, 836 may include a different dye or colorant. Accordingly, a user may be able to determine if detection device 800 has been exposed to temperatures exceeding one or more threshold temperatures using color. For example, first material 806 may include a yellow dye or colorant, second material 826 may include a blue second dye or colorant, and material 836 may include a red dye or colorant. Should only first material 806 partially melt or deform, the at least partially melted or deformed material may only be yellow. Should both first material 806 and second material 826 partially melt or deform, the at least partially melted or deformed material may be green. Other colors may be utilized.

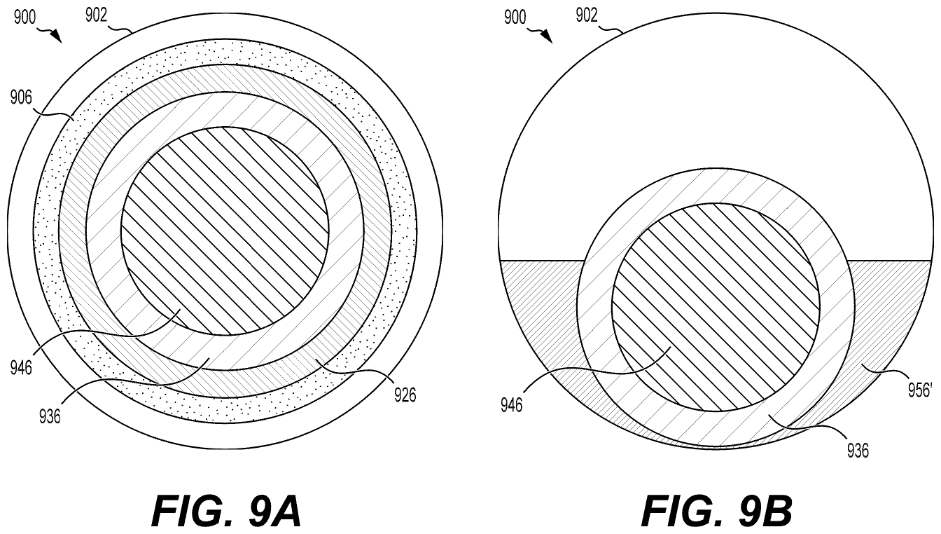

FIGS. 9A and 9B illustrate a vertical cross-section of an alternative exemplary detection device 900 at a first temperature (FIG. 9A) and at a second temperature (FIG. 9B). Detection device 900 may have any or all of the same characteristics of any detection device previously described, except as described below.

For example, detection device 900 may include a reservoir 902 and one or more materials disposed within reservoir 902. The materials may include a first material 906, a second material 926, a third material 936, and a fourth material 946. In aspects, the plurality of materials may include fewer materials (e.g., one, two, three, etc., materials) or additional materials (e.g., five, six, etc., materials). The materials may be arranged one inside the other, similar to an onion. For example, materials 906, 926, 936, 946 may be frozen or molded together in layers. In some aspects, materials 906, 926, 936, 946 may form a sphere, although any other 3-dimensional shape may be contemplated.

Similar to detection devices 200, 400, 600, or 800, detection device 900 may be utilized, for example, to approximate a highest temperature range to which detection device 900 has been exposed. For example, each of materials 906, 926, 936, 946 may have different melting points. First material 906 may have a lowest melting point and may form an outer layer of the sphere; second material 926 may have a higher melting point as compared to first material 906; third material 936 may have a melting point that is higher than both first material 906 and second material 926, etc. In these aspects, as detection device 900 is exposed to increasing temperatures, first material 906, second material 926, third material 936, or fourth material 946 may melt in succession.

A user may be able to approximate a highest temperature above which detection device 900 was exposed to, for example, by observing the solid material, if any, that remains in reservoir 902. In some aspects, each material may include a colorant or a dye to assist the user in visualizing the material. For example, first material 906 may be blue, second material 926 may be yellow, third material 936 may be orange or red, and fourth material 946 may be black. For example, if a user were to observe detection device 900 at the second temperature, falling between the melting point of materials 926 and 936 (shown in FIG. 9B), a user may see an at least partially melted or deformed material 956′ (e.g., comprised of melted first material 906 and melted second material 926). The user may also see third material 936 in a solid state. For example, the user may observe a red sphere disposed within reservoir 902.

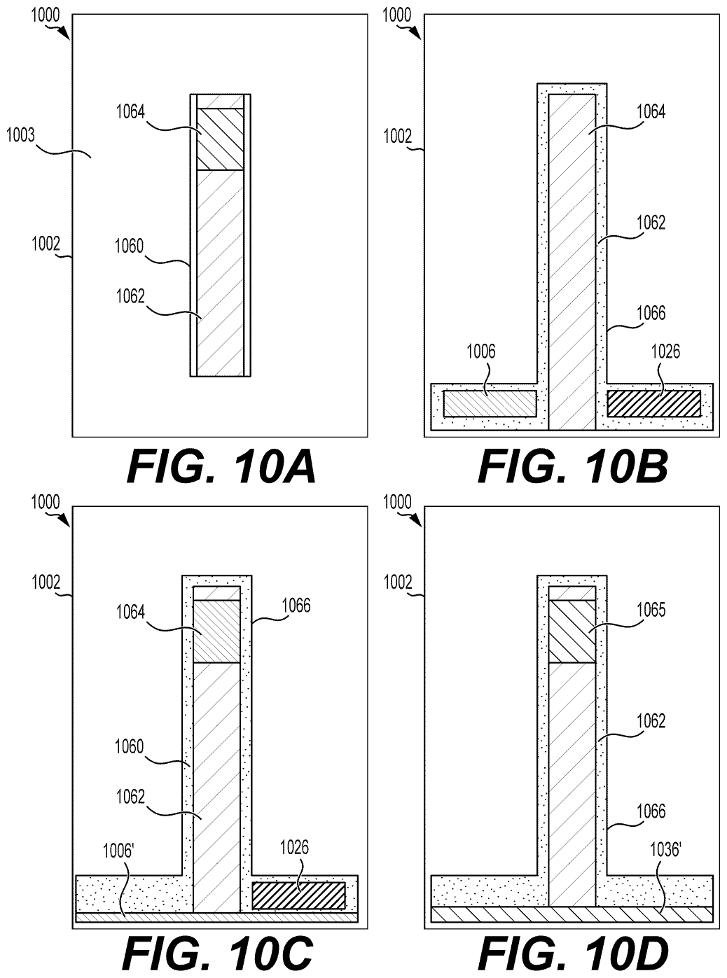

FIGS. 10A-10B illustrate an alternative detection device 1000. Detection device 1000 may be configured to provide a visual indication of whether detection device 1000 has been exposed to a temperature above a certain threshold. In particular, detection device 1000 may be configured to measure a pH of an at least partially melted material or combination of materials. FIG. 10A illustrates a front schematic view of detection device 1000. FIGS. 10B-10C illustrate detection device 1000 with a portion (e.g., a cover 1003 of a cartridge 1002) removed. In particular, FIG. 10B illustrates detection device 1000 at a first temperature, FIG. 10B illustrates detection device 1000 at a second temperature, and FIG. 10C illustrates detection device 1000 at a third temperature.

Referring to FIG. 10A, detection device 1000 may include a cartridge 1002. Cartridge 1002 may include a window 1060 for viewing a litmus paper 1062. Litmus paper 1062 may be disposed within a cavity 1066 (FIGS. 10B-10C) of cartridge 1002. Shown in more detail in FIGS. 10B-10D, cavity 1066 may be “T” shaped. In some aspects, cavity 1066 may be configured as an upside down “T”. At the first temperature, a first material 1006 and a second material 1026 may be disposed on either side of litmus paper 1062. The first material 1006 and the second material 1026 may be in a frozen, or solid, state at the first temperature, which may be below a first threshold. First material 1006 and second material 1026 may have a same or different melting temperatures. For example, a melting temperature of first material 1006 may be approximately −40 degrees, and a melting point of second material 1026 may be approximately −20 degrees. In aspects, first material 1006 may have a first pH value, and second material 1026 may have a second pH value, different than the first pH value.

FIG. 10C illustrates detection device 1000 at a second temperature above a first threshold which may correspond to the melting temperature of first material 1006. At the second temperature, first material 1006 may at least partially melt or deform. Accordingly, material 1006′ may pool at the bottom, or base, of cavity 1066. Material 1006′ may contact litmus paper 1062, and litmus paper 1062 may react. For example, litmus paper 1062 may change a color of litmus paper 1062 that is indicative of the pH of material 1006′. In some aspects, an indicator 1064 may appear on litmus paper 1062. At the second temperature, second material 1026 may remain in a frozen, or solid state.

FIG. 10D illustrates detection device 1000 at a third temperature above the first threshold and above a second threshold, which may correspond to the melting temperature of second material 1026. At the third temperature, both first material 1006 and second material 1026 may at least partially melt or deform. Second material 1026 may melt after first material 1006. Accordingly, a mixture 1036′ of first melted material 1006 and melted second material 1026 may pool at the bottom, or base, of cavity 1066. In aspects, for example, when second material 1026 melts, a pH value of mixture 1036′ may be different as compared to a pH of material 1006′. Accordingly, when mixture 1036′ contacts litmus paper 1062, litmus paper 1062 may change a different color compared to the color of the litmus paper 1062 when only in contact with 1006′. In some aspects, a second or alternative indicator 1065 may be visible.

A user may utilize detection device 1000, for example, to approximate a temperature range above which detection device 1000 was exposed to. For example, if detection device 1000 is exposed to a temperature such that indicator 1064 reads a pH value approximately equal to the pH value of first material 1006, this may be indicative that detection device was exposed to a temperature greater than the first threshold corresponding to the melting point of first material 1006, but lower than the second threshold corresponding to the melting point of second material 1026. Similarly, if detection device is exposed to a temperature such that indicator 1065 reads a pH value approximately equal to the pH value of mixture 1036′ (e.g., a mixture of first material 1006 and second material 1026), this may be indicative that detection device was exposed to a temperature greater than the second threshold and thus greater than the melting point of both first material 1006 and second material 1026.

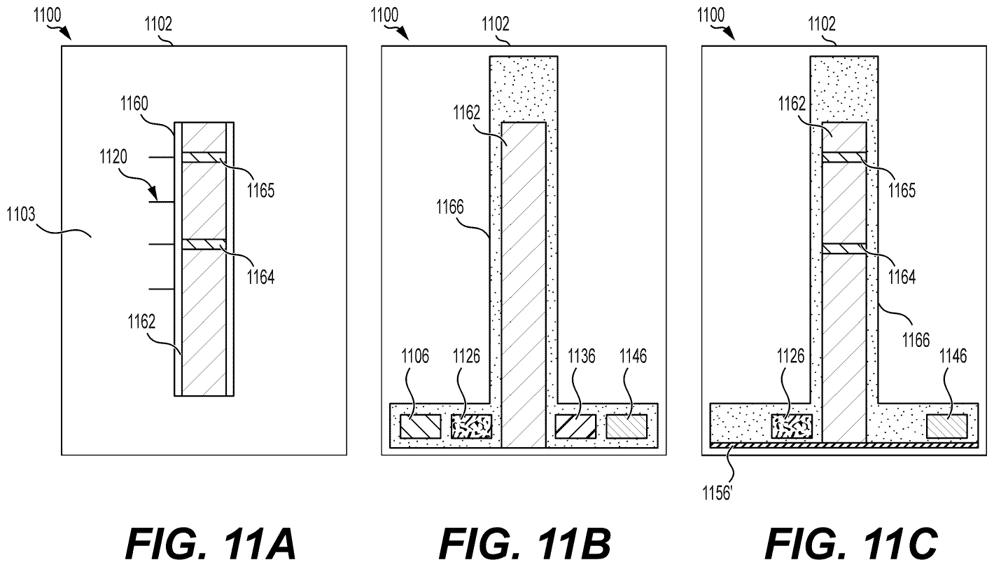

FIGS. 11A-11B illustrate an alternative detection device 1100. Detection device 1100 may be configured to provide a visual indication of whether detection device 1100 has been exposed to a temperature above a threshold. In particular, detection device 1100 may be configured to measure a presence of a biological substance (e.g., an antibody) of a partially melted or deformed solution or combination of solutions. FIG. 11A illustrates a front view of detection device 1100. FIGS. 11B-10C illustrate detection device 1100 with a portion (e.g., a cover 1103 of a cartridge 1102) removed. In particular, FIG. 11B illustrates detection device 1100 at a first temperature, below a threshold, and FIG. 10B illustrates detection device 1100 at a second temperature, above the threshold.

In particular, detection device 1100 may operate similarly to an antibody test or flow assay. For example, detection device 1100 may be configured to measure one or more antibodies in a liquid. The antibodies may be initially trapped within a frozen or solid solution. As the melting temperature of the solid solution is reached (e.g., when detection device 1100 is exposed to a temperature that is higher than a threshold temperature corresponding to the melting point of the solution), the solution may being to at least partially melt or deform. Accordingly, the melted solution (and thus the antibodies) may come in contact with an assay paper.

Referring to FIG. 11A, detection device 1100 may include a cartridge 1102 having a window 1160 for visualizing a portion of an assay paper 1162. FIG. 11B illustrates detection device 1100 with a cover 1103 removed. A cavity 1166 may be defined within cartridge 1102. Similar to detection device 1000 of FIGS. 10B-10D, cavity 1166 may be “T” shaped. Assay paper 1162 may be disposed within cavity 1166. In aspects, at the first temperature, below the threshold temperature, one or more solutions may be disposed on either side of assay paper 1162. For example, FIG. 11B illustrates two solutions disposed on either side of assay paper 1162. The solutions may include a first solution 1106, a second solution 1126, a third solution 1136, and a fourth solution 1146. In aspects, the one or more solutions may have different melting points and may contain different antibodies.

For example, at the first temperature (FIG. 11B), none of the solutions may be at least partially melted or frozen, and the temperature may be below the threshold melting point of all of the solutions. At the second temperature (FIG. 11C), two solutions (e.g., first solution 1106 and third solution 1136) may be at least partially melted or deformed. In some aspects, a mixture 1156′ of first solution 1106 and third solution 1136 may pool at the bottom of cavity 1166. Mixture 1156′ may contact assay paper 1162. Due to the presence of two different antibodies (e.g., one from first solution 1106 and one from third solution 1136) within mixture 1156′, a first indicator 1164 and a second indicator 1165 may be visible on assay paper 1162. For example, first indicator 1164 may be indicative of the antibodies detected from first solution 1106, and second indicator 1165 may be indicative of the antibodies detected from third solution 1136.

Accordingly, a user may use indicators 1164, 1165 to approximate a temperature above which detection device 1100 was exposed. For example, if detection device 1100 was not exposed to temperatures that would otherwise result in second solution 1126 or fourth solution 1146 melting, antibodies present within second solution 1126 and fourth solution 1146 may not be detected. The presence of no indicators may indicate that detection device 1100 was not exposed to a temperature that would otherwise result in one or more of solutions 1106, 1126, 1136, 1146 from at least partially melting or deforming.

Referring back to FIG. 11A, markings 1120, or indicator lines, on cartridge 1102 may be present, for example, to assist a user in determining an approximate temperature threshold detection device 1100 was exposed to. For example, if first solution 1106 had a melting point of approximately −40 degrees Celsius, second solution 1126 had a melting point of approximately −20 degrees Celsius, third solution 1136 had a melting point of approximately −30 degrees Celsius, and fourth solution 1146 had a melting point of approximately −10 degrees Celsius, the presence of indicators 1164 and 11645 (as shown in FIG. 11A) may provide a visual indication that detection device 1100 was exposed to a temperature between approximately −30 degrees Celsius and approximately −20 degrees Celsius. If all indicators at all indicator lines 1120 were present due to the detection of antibodies from solutions 1106, 1126, 1136, 1146, then it would be known that device 1000 had been exposed to a temperature above the highest threshold, corresponding to the melting temperature of the solution with the highest melting point.

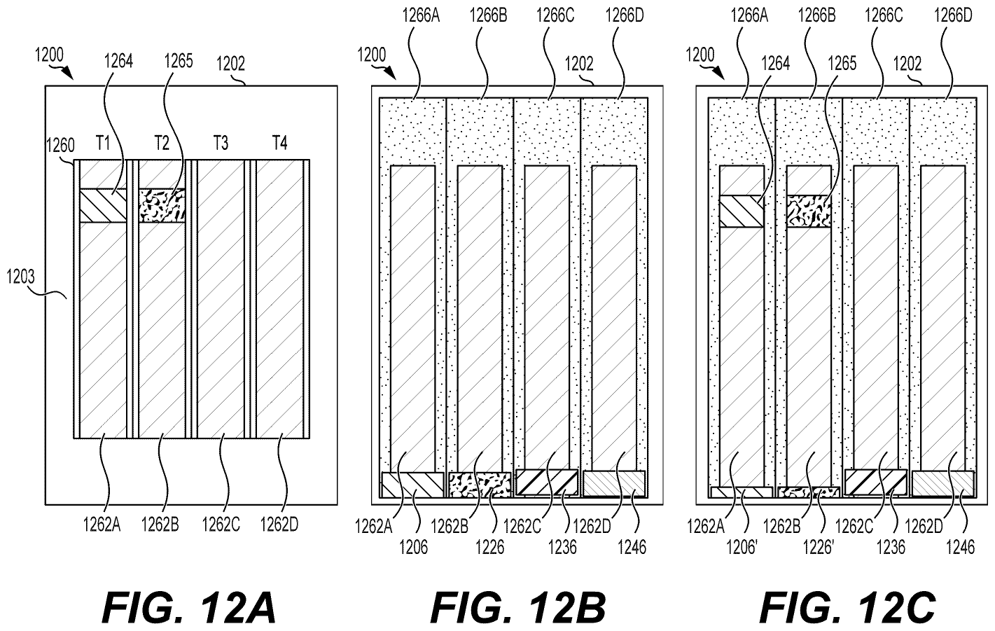

FIGS. 12A-12C illustrate an alternative exemplary detection device 1200. For example, FIG. 12B illustrates detection device 1200 at a first temperature, lower than a first threshold, and FIGS. 12A and 12C illustrate detection device 1200 at a second temperature, higher than the threshold. In particular, FIGS. 12B and 12C illustrate detection device 1200 with a portion (e.g., a cover 1203 of a cartridge 1202 removed).

Detection device 1200 may have any or all of the same characteristics of detection device 1000 or detection device 1100, except as described below. For example, detection device 1200 may utilize the pH of one or more melted solutions to determine a temperature threshold above which detection device 1200 was exposed, or detection device 1200 may utilize the presence of antibodies of one or more melted solutions to determine a temperature threshold above which detection device 1200 was exposed. In particular, a primary difference between detection device 1200 and detection devices 1000 or 1100 is that detection device 1200 may include individual testing papers (e.g., individual litmus papers or assay papers) for each solution disposed within detection device 1200.

For example, FIG. 12A illustrates a front view of detection device 1200 at a temperature that is above a melting point of solutions 1206 and 1226. Detection device 1200 may include a cartridge 1202 defining a window 1260. One or more testing papers may be visible within window 1260. For example, a first testing paper 1262A, a second testing paper 1262B, a third testing paper 1262C, and a fourth testing paper 1262D may be visible within window 1260.

FIGS. 12B and 12C illustrate detection device 1200 with a cover 1203 removed. In particular, a number of cavities (e.g., corresponding to a number of testing papers present within detection device 1200) may be defined. FIGS. 12B and 12C illustrate four cavities: a first cavity 1266A, a second cavity 1266B, a third cavity 1266C, and a fourth cavity 1266D, although any suitable number of cavities may be included in detection device 1200. At a first temperature, a solution in a frozen or solid state may be disposed within a bottom portion of each cavity. For example, a first solution 1206 may be disposed within first cavity 1266A, a second solution 1226 may be disposed within second cavity 1266B, a third solution 1236 may be disposed within third cavity 1266C, and a fourth solution 1246 may be disposed within fourth cavity 1266D. Each solution may have a same or different melting temperature. As previously described, each solution may have a different pH or may contain a different antibody.

At the first temperature (FIG. 12B), detection device 1200 may be exposed to a temperature that is lower than the melting temperature of each solution 1206, 1226, 1236, 1246. At a second temperature (FIG. 12C), detection device 1200 may be exposed to a temperature that is greater than the melting temperature of first solution 1206 and second solution 1226, but less than the melting temperature of third solution 1236 and fourth solution 1246. Accordingly, melted first solution 1206′ and second solution 1206′ may at least partially come in contact with first testing paper 1262A and second testing paper 1262B, respectively. In these aspects, a first indicator 1264 and a second indicator 1265 may be visible on first testing paper 1262A and second testing paper 1262B, respectively. For example, first testing paper 1262A may measure a pH of first solution 1206′ or detect an antibody within first solution 1206′, thus resulting in a first indicator 1264. Similarly, second testing paper 1262B may measure a pH of second solution 1226′ or detect an antibody within second solution 1226′, thus resulting in second indicator 1265.

Third solution 1236 and fourth solution 1246 may remain in a solid or frozen state because the melting temperature of these solutions has not been reached or exceeded. Accordingly, no indicators may be present on third testing paper 1262C or fourth testing paper 1262D. In these aspects, a user may be able to use indicators 1264, 1265 to approximate that detection device 1200 was exposed to a temperature that was less than the approximate melting temperature of third solution 1236 and fourth solution 1246, but greater than the approximate melting temperature of first solution 1206 and second solution 1226.

Embodiments disclosed herein may be configured to provide one or more visual indicators that a detection device has been exposed to a temperature above one or more temperature thresholds. Aspects of the disclosures discussed herein may use colors, shapes, volumes, etc., for example, to indicate to a user if a threshold temperature has been reached or exceeded. Aspects of each of the embodiments disclosed herein may be used alone or in combination with one another.

While principles of the present disclosure are described herein with reference to illustrative aspects for particular applications, it should be understood that the disclosure is not limited thereto. Those having ordinary skill in the art and access to the teachings provided herein will recognize additional modifications, applications, aspects, and substitution of equivalents that all fall within the scope of the aspects described herein. Furthermore, the present disclosure is not limited to the exemplary shapes, sizes, solution, or materials, orientations, or arrangements discussed herein. Thus, a person of ordinary skill in the art will recognize that additional alternative shapes, sizes, solution types, or materials, numbers and combinations of solutions or materials, numbers of reservoirs, orientations of reservoirs, etc., may be used as discussed herein to achieve the same or similar effects or benefits as discussed above. Accordingly, the present disclosure is not to be considered as limited by the foregoing description.

What is claimed is:

1. A device for detecting a temperature above a threshold temperature, the device comprising:
a first reservoir; and
a second reservoir fluidly connected to the first reservoir;
wherein, when the device is exposed to a temperature at or below the threshold temperature, a material is disposed within the first reservoir, and
wherein, when the device is exposed to a second temperature greater than the threshold temperature, at least a portion of the material is disposed within the second reservoir.

2. The device of claim 1, wherein the threshold temperature is approximately −40 degrees Celsius.

3. The device of claim 2, wherein the threshold temperature is approximately −20 degrees Celsius.

4. The device of claim 1, further comprising a third reservoir in fluid communication with the first reservoir, wherein the first reservoir is disposed between the second reservoir and the third reservoir.

5. The device of claim 1, wherein a surface defining a floor of the first reservoir is positioned relatively higher than a surface defining a floor of the second reservoir.

6. The device of claim 1, further comprising a third reservoir in fluid communication with the first reservoir, wherein the second reservoir is disposed between the first reservoir and the third reservoir.

7. The device of claim 6, wherein a surface defining a floor of the first reservoir is positioned relatively higher than a surface defining a floor of the second reservoir and a surface defining a floor of the third reservoir.

8. The device of claim 6, wherein a first one-way valve is disposed between the first reservoir and the second reservoir, and a second one-way valve is disposed between the first reservoir and the third reservoir.

9. The device of claim 6, wherein a second material is disposed in the third reservoir at the temperature when the device is exposed to a third temperature below the threshold temperature, and wherein the second material is different from the first material.

10. A device for detecting a temperature above or below a threshold temperature, the device comprising:
a frame defining a reservoir therein, wherein the reservoir includes a plurality of arms extending radially out from a central portion, wherein the reservoir is configured to contain a material in one of the central portion or at least one arm of the plurality of arms when the device is exposed to a temperature below the threshold temperature, and wherein, when the device is exposed to a temperature above the threshold temperature, the material is at least partially disposed in a different portion of the reservoir.

11. The device of claim 10, wherein the threshold temperature is −40 degrees Celsius.

12. The device of claim 10, wherein the threshold temperature is −20 degrees Celsius.

13. The device of claim 10, wherein the material is a first material disposed within one of the plurality of arms, and wherein a second material is disposed in another arm of the plurality of arms.

14. The device of claim 13, wherein the first material has a first melting temperature, and the second material has a second melting temperature, wherein the first melting temperature is greater than the first melting temperature.

15. The device of claim 14, wherein the first material has a first color, and the second material has a second color.

16. A device for detecting a temperature above or below a threshold temperature, the device comprising:
a cartridge defining an internal cavity and a window;
a testing paper disposed within the internal cavity and visible through the window; and
at least one solution disposed within the internal cavity,
wherein, at a temperature below the threshold temperature, the at least one solution is in a solid state, and, at a temperature above the threshold temperature, the at least one solution is at least partially in a liquid state such that the liquid contacts the testing paper, causing a reaction with the testing paper.

17. The device of claim 16, wherein the testing paper is configured to measure a pH of the at least one solution in the liquid state or a presence of an antibody in the at least one solution in the liquid state.

18. The device of claim 17, wherein a melting temperature of the at least one solution is approximately equal to the threshold temperature.

19. The device of claim 16, wherein the testing paper is a first testing paper, and the at least one solution is a first solution, wherein the device further comprises a second testing paper and a second solution.

20. The device of claim 19, wherein a melting temperature of the first solution is less than a melting temperature of the second solution.
